(19) United States
(12) Patent Application Publication
(10) Pub. No.: US 2015/0365657 A1
(43) Pub. Date: Dec. 17, 2015

(54) Text and graphics interactive display

(71) Applicant: Gerald S. Karr, Venice, CA (US)

(72) Inventor: Gerald S. Karr, Venice, CA (US)

(21) Appl. No.: 14/120,695

(22) Filed: Jun. 16, 2014

(51) Int. Cl. H04N 13/04; H04N 13/02; G06F 3/01; H04N 7/18; G06F 3/041; G06F 3/0488

(52) U.S. Cl. CPC H04N 13/0456; G06F 3/0412; G06F 3/0488; G06F 3/011; H04N 7/183; H04N 13/0409; H04N 13/0275; H04N 13/0459; H04N 2213/005; H04N 2213/003; H04N 2213/006; G06F 2203/04101

(57) ABSTRACT

A system for rendering interactive text and graphic images on a standard 2-dimensional electronic display screen, giving the appearance of a 3-dimensional image through the use of interactive 3D projection onto the 2D surface, using parallax, true 3D, pseudo 3D, and responsive to user input and automatic timing algorithms. It will be seen that the same system can readily be adapted to a true 3D display system, should cost and/or space permit. The advantages of this system include increased viewing comprehension, reduced fatigue, and efficiency of computational implementation.

### BACKGROUND OF THE INVENTION

Electronic displays have become ubiquitous in the modern world, but the display of images, particularly images of text, outside of improvements in display resolution, has stayed the same. Electronic screens are, in comparison to real-world sights such a person would see when walking around, static and fatiguing to the eye. This is because the human eye thrives on and is sensitive to changes.

For the most part, text and graphic images are not interactive and do not change their appearance according to user input, as opposed to the constantly varying images seen by a person walking around. The visual quality of text is also uninteresting when compared to the interactive graphics of games and movies that can be viewed on modern day screens. Text would appear to be almost an afterthought, as if it has been hidden from advancements in computational power and display screen resolution.

It is therefore the object of this invention to declare the necessity of improving the appearance of text in electronic display screens, as well as to provide concrete methods for achieving it. This will reduce user fatigue and likely improve comprehension due to the reduction in boredom.

The method of improving the appearance of text is to give it a 3-dimensional appearance. This does not require the use of a true 3-D or Stereoscopic display, although such displays would be easily adaptable to the present invention, as will be explained in the detailed description. More likely, due to cost and size constraints, a standard 2-D screen will be used to convey the 3D image to the user. This will be accomplished by allowing the text to change appearance based on user input, and the resulting interaction will convey a sense of movement to the user—much the same as a sense of 3-dimensionality is conveyed to the viewer of a motion picture, when viewing the movie on a 2-D screen.

### SUMMARY

The present invention will outline specific methods to provide a 3D interactive appearance to text and graphics on a 2D display screen. It will be seen that the same system can readily be adapted to a true 3D display system, should cost and/or space permit. The purpose will be to make the display more interesting which will in turn reduce user fatigue and improve comprehension.

### BRIEF DESCRIPTION OF THE DRAWINGS

FIG. 1 is a standard san-serif font of the letter “L” in 2-D. This font will be used for all examples in this provisional application, because of ease of drawing it and ease of explaining the concepts claimed in this invention. A further simplification will also be made, which is to use only the letter “L” because it is easy to draw and visualize. The astute reader will quickly realize that any letter or font could be used and/or modified using the methods that will be described.

FIG. 2a shows the 2-D font of FIG. 1 being made into a 3-D font by simply giving it a z value of n, where n is set according to user inputs and interactions. FIG. 2b shows the same font with artificial texture added.

FIG. 3 shows various perspectives in which the font of FIG. 2 can be displayed, depending on the point of view (POV) of the viewer. FIG. 3a has a POV of upper left, FIG. 3b is upper center, FIG. 3c is upper right, FIG. 3d is middle left, FIG. 3e is middle center (note 3-D information is nonexistent in this POV,) FIG. 3f is middle right, FIG. 3g is lower left, FIG. 3h is lower center, and FIG. 3i is lower right. These figures are selected to illustrate some of the possible POVs, but in practice, a continuous range of POVs is used to obtain the smooth motion which will create the illusion of 3-D.

FIG. 4 shows a row of letters as used in a word or a sentence, but all using the letter “L” for simplicity, and all having the same POV, which in this case is lower left. It is quite likely that and entire row of text would be rendered in this manner of having the same POV, even though it is not truly realistic. It is not realistic because in reality each letter would have a slightly different POV due to differences in their relative position to the eye or eyes. In the present invention we are saying that we probably can ignore minor differences in POV such as these, but if one wants to be completely rigorous and if the computational resources and high definition screen are available, and especially if the images are rendered into two image buffers for stereoscopic viewing, then different POVs for each letter may be calculated.

FIG. 5a through FIG. 5i are the “neon sign” 3D representations which are explained in the detailed description.

FIG. 6 is an overview of this entire interactive graphics system.

### DETAILED DESCRIPTION

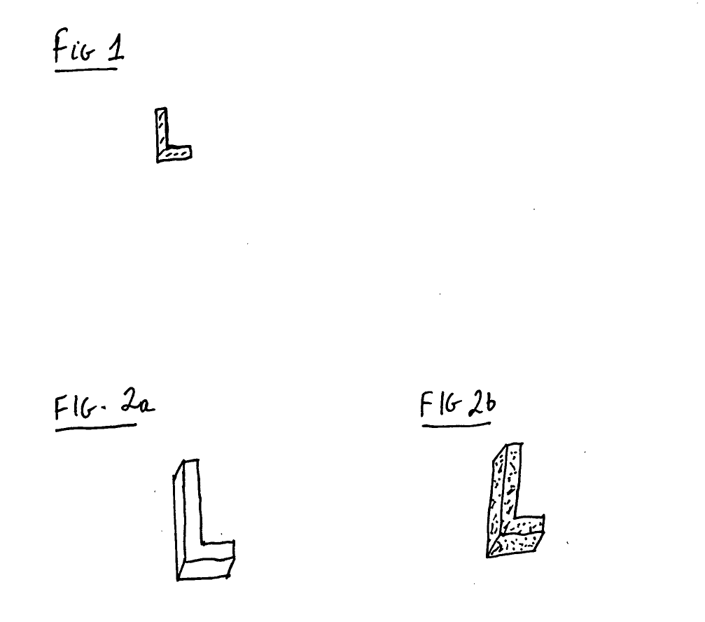

In the preferred embodiment, which is the simplest computationally except for the “neon sign” implementation discussed later, a 2-D font is chosen by the user, the same as in any computer application. There are no restrictions whatever on the font, other than that it must be legible. This is shown in FIG. 1.

Next, a z-value is assigned to the font, which was previously generated by the user interface (UI). This value will be called u. Then a 3-D database is created for the letter. The bottom surface of the font is the original rendered font with z=0 for each point in the font. Then the top surface is put into the database. The top surface is an exact copy of the bottom surface with z=u for each point in the font. Then the sides of the font will be placed in the database. The sides follow the surface of the font all the way around it, and have all possible z values between 0 and u, constrained by the computational resolution.

The database will be updated for each letter that will be shown on the display screen.

The screen buffer will then be loaded with a projection of this 3D database onto the 2D screen, according to the rules of geometry, using parameters previously determined by the UI, such as POV, including whether there is a single POV or multiple POVs. POV information includes all the degrees of rotation that are needed to convey the POV, as well as the distance of the viewer from the text. It is the distance information that will determine, for example, whether adjacent letters appear similarly or radically different. The astute reader will realize that rather than a 2D screen, a 3D screen could be used. This we would assume to be stereoscopic, and if such is the case, then two separate 2D projections would be calculated according the rules of geometry, each with a slightly different POV.

The screen buffer will be updated as often as needed. Events which cause it to be updated include changes to the text which needs to appear on the screen, and changes to the POV, determined by the UI.

In an alternative embodiment, the 2D font can be modified first, and them the conversion to 3D as described above can be implemented. Said modification of 2D font could be a geometrical transformation to provide more of a realistic 3D effect. This would include a true perspective in which the character footprint would be smaller on the top than at the bottom, because the top corresponds to the “farther away” portion of the character. However, one can go to far and create what is known as the Star Wars effect, because then the reader will have a difficult time reading the display. Therefore we tend to favor a pseudo 3D approach in which the characters appear to be in 3D but lack adherence to certain real world considerations.

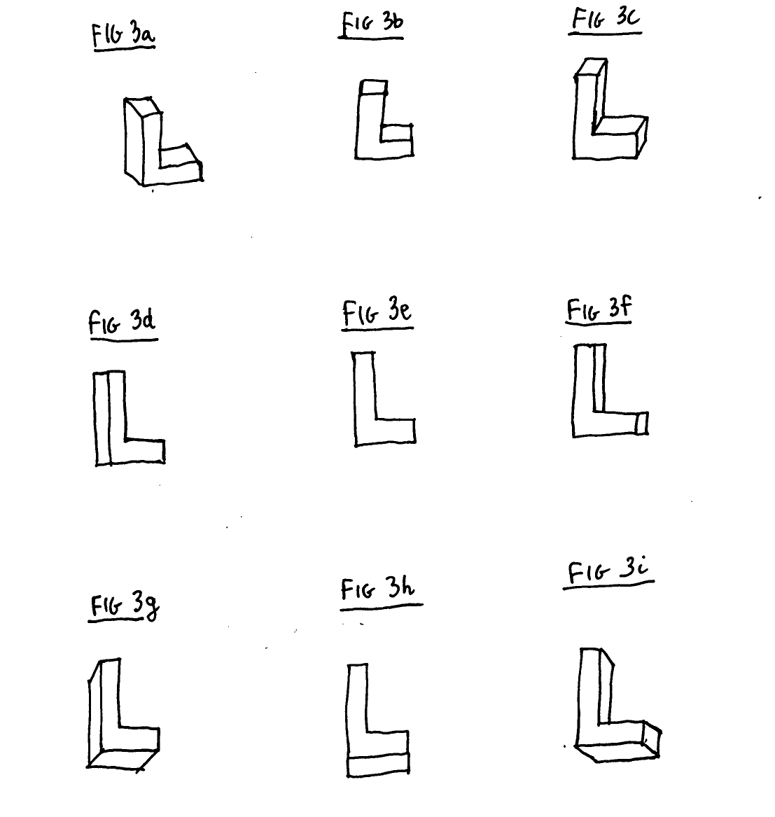

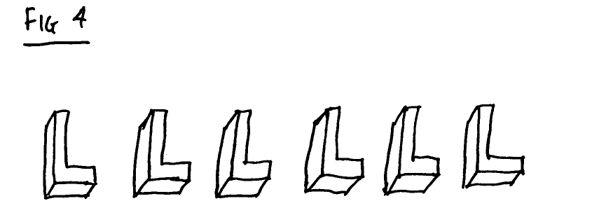

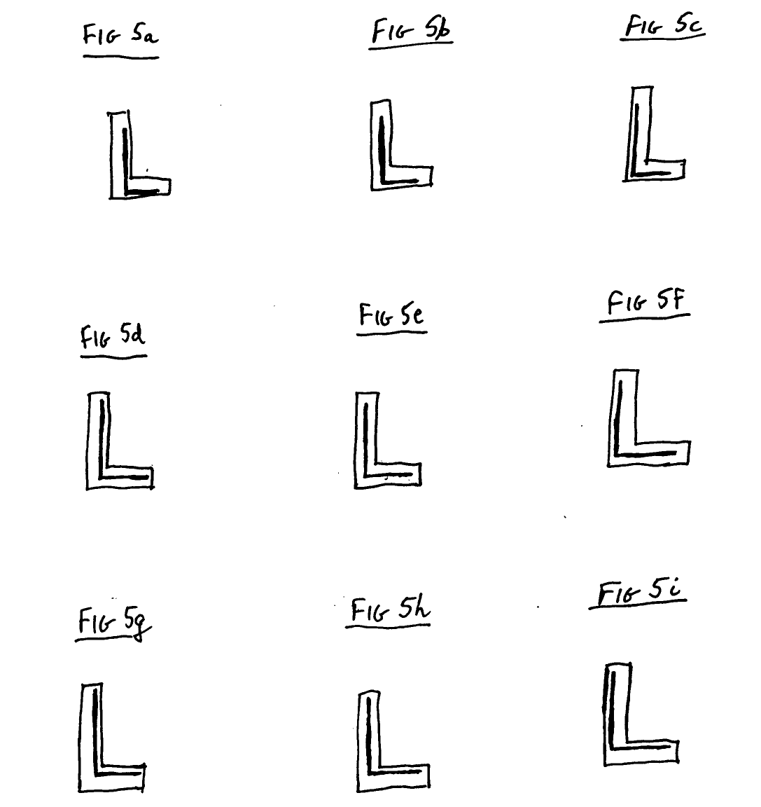

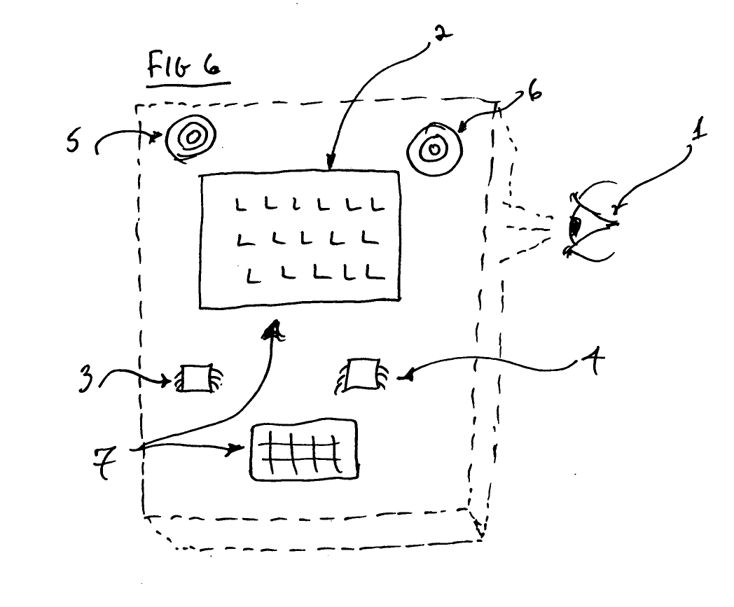

We now present an alternative method of achieving an illusion of depth, which requires even less computation. We will call this the Neon Sign method, because one can visualize it as an old neon sign in which each letter is backed by a white (the color is not important) piece of metal. The neon tube itself is some distance in front of this “reflector,” perhaps an inch or two. When a viewer moves their head or eyes around, they see the 3D or parallax effect, which is that the neon “font” moves relative to the background reflector. This is illustrated in FIG. 5 a through i, in which the POVs are the same as they are for FIG. 3. There are various ways that the computations could be performed to achieve this result on the display screen. In one method, after a font is chosen, an algorithm could create the “neon” element which would be a line inside of the font, specifically the line in FIG. 5e. Then, the POV could simply cause the “neon” to move in 2D space over and around the font, and this would give the illusion of 3D. In this case, the repetitive multiplications with sine and cosine would not be necessary. The UI would still be the same, and it would deliver the POV to this rendering engine.

Again in the spirit of this invention, there are various other methods of calculating the screen buffer which fall between these two methods in complexity. They all have in common that the UI is sending POV information to the text and font rendering software.

Looking now at FIG. 6, we will describe the overview of the basic system. This includes 1=the user's eye, 2=the display screen, 3=the gravity or tilt sensor, 4=the accelerometer, 5=camera pointed toward the viewer's face, 6=optional second camera pointed toward the user's face, and 7=user controls such as touch screen or other buttons or knobs. The gravity or tilt sensor will send data to the UI which will be used to help determine the horizon angle of the viewer. The accelerometer will perform a “dead reckoning” assessment of whether the display screen has moved. The camera will give an assessment of the position of the user's head or eye relative to the screen. This would be most reliably x-y information, but it could also be possible to provide information in the z-axis according to focus information feedback from the camera. It would also be possible to calculate z-axis information if two cameras were used, using triangulation. The z-axis information, like the other parameters just mentioned, will be used to arrive at a final determination of POV which will then be sent to the graphics renderer.

Buttons, knobs, or touchscreen controls will also be used to set global parameters, such as font height. This is the z-parameter that is used in creating the 3D database, prior to screen buffer calculation. For example, if z is set at a very small value, the effects of the present invention will be subtle, but still valuable. If z is set for a larger value, then the effects will be more pronounced. Therefore the user is given the option of “dialing in” this parameter according to their preference.

Up to this point in the description we have not made a distinction between hand held and fixed displays. Let us clarify then, that while much of the UI has taken into account things that are only available on a hand-held display, for example, accelerometers, the present invention can still be used with fixed displays. A method will need to be provided for determining the POV. This could be one or two cameras pointing towards the user's face, or it could be a transponder placed on the user's head, or one of many other possible methods such as an infrared LED array.

We will now describe the UI. As mentioned, a key parameter set by the user will be z-height of the fonts. The method in which this parameter is set could be as simple as setting the brightness of the display, or it could even be some sort of interactive thing such as moving the device in a certain gesture. More likely than not, a slider could be provided for easy access to this control.

The gravity, tilt, and accelerometer inputs will first be filtered to remove irregularities, most likely with an FIR filter. Then, they would be tracked by an algorithm that looks at long-term and short-term changes. This will all be combined with any optional face-tracking camera data to help to arrive at the tilt relative to both horizontal and the user's face. It is possible that the tracking algorithm will self-reset, which is to say it will zero out it's coefficients after a long time of stability. In other words, if the user is holding the display at any particular angle for a long time, this may become the “new normal.”

Another parameter than can be set by the user, probably through the use of a touch screen or other controls, is the font color or colors. The top, bottom, and sides of the 3D font can all be different colors, and the colors can also be set up as a gradient.

Another parameter that can be set by the user is opacity. The top will not have to be 100% opaque, for example. Likewise the sides could be any level of opacity, including 0, in which case the sides would not appear at all. Note that the invention would still function and a 3D effect would still be seen, even without sides. And, the bottom, while not often seen, would be seen in the case of the top or sides having less than 100% opacity, or if the “neon sign” implementation is used.

Colors can also be slightly or majorly modified by the UI. And the computer's automatic algorithms can use timers to adjust many of the same parameters as the user controls can. The timers in the automatic algorithms can be as complex as necessary, with one timer's completion signaling the beginning of another timer, for example. The timers can add subtle changes to the texture, colors, opacity, radius, and 3D or pseudo 3D projection. It is these automatic timing algorithms that may decrease eye fatigue even more, because the human eye thrives on changes and becomes bored and fatigued by static images. And any modifications that can make the text or graphics seem more like real-world images, will improve the human experience of looking at the display.

Another parameter than can be set by the user is texture. Various texture map choices could be presented to the user for choice, or the user could even draw some sort of doodle or squiggly line drawing that could be translated into the font texture. Different textures could be chosen for the top, bottom, and sides, if desired.

Another parameter that could be chosen by the user is radius. The corners of the font where the sides meet the top and bottom could be defined to have a certain radius, and this radius could used font rendering. This would give the font a smoother look.

It is important to realize that the UI, once all of the elements in the above description are in place, can be elaborated upon while staying within the spirit of this invention. The main point of this invention is to add an interesting and changing look to the display screen to reduce user fatigue and thereby increase comprehension and enjoyment. To this end, the computer itself can add to the variations. In fact there can be a user-specified parameter that specifies the limit of the computer-initiated changes. The computer could randomly vary the opacity or color of the characters, for example.

Now considering all that has been described above, modifications may and will be made by those skilled in the art, without departing from the spirit of this invention.

I claim:

1. Presentation of text and graphics on a two dimensional (2D) electronic display screen, giving the appearance of three dimensionality (3D) and where the appearance will change based on user input and/or time varying computer generated or random input. Changes can include but are not limited to changes in 3D perspective, brightness, radius, texture mapping, and color.

2. Presentation of text and graphics on a two dimensional (2D) electronic display screen, giving the appearance of three dimensionality (3D) or pseudo 3D in which there may be distortions that increase readability which are not true 3D in nature, and where the appearance will change based on user input and/or time varying computer generated or random input. Changes can include but are not limited to changes in 3D perspective, brightness, radius, texture mapping, and color.

3. The presentation of claim 1, wherein the user input is provided via user controls such as a touch screen.

4. The presentation of claim 1, wherein the user input is provided via a gravity sensor or tilt sensor or accelerometer.

5. The presentation of claim 1, wherein the user input is provided by an image sensor such as a front-facing camera, said camera being focused on the user's hands or face.

6. The presentation of claim 1, wherein the computer input is provided by a software timing algorithm triggering randomly selected events.

7. The presentation of claim 1, wherein the computer input is provided by a software timing algorithm triggering a preset list of events.

8. The presentation of claim 2, wherein the user input is provided via user controls such as a touch screen.

9. The presentation of claim 2, wherein the user input is provided via a gravity sensor or tilt sensor or accelerometer.

10. The presentation of claim 2, wherein the user input is provided by an image sensor such as a front-facing camera, said camera being focused on the user's hands or face.

11. The presentation of claim 2, wherein the computer input is provided by a software timing algorithm triggering randomly selected events.

12. The presentation of claim 2, wherein the computer input is provided by a software timing algorithm triggering a preset list of events.

13. The presentation of claim 1 in which the text and graphics including modifications triggered by the user interface and computer timer algorithms, are presented on a 3D or stereoscopic display apparatus.

14. The presentation of claim 2 in which the text and graphics including modifications triggered by the user interface and computer timer algorithms, are presented on a 3D or stereoscopic display apparatus.
